(19) United States
(12) Patent Application Publication
(10) Pub. No.: US 2007/0165088 A1
(43) Pub. Date: Jul. 19, 2007

(54) Image forming apparatus

(75) Inventors: Yutaka Maeno, Kanagawa-ken (JP); Tetsuzo Kadomatsu, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/652,000

(22) Filed: Jan. 11, 2007

(30) Foreign Application Priority Data
Jan. 13, 2006 (JP) 2006-006549

(51) Int. Cl. G01D 11/00

(52) U.S. Cl. 347/100

(57) ABSTRACT

The image forming apparatus has a shear mode liquid ejection head for ejecting ink, the shear mode liquid ejection head including: a pressure chamber into which the ink is filled; and a liquid affinity film which is made from a material containing a polyparaxylylene or a derivative of polyparaxylylene and is formed on an interior wall of the pressure chamber, wherein the ink is an oil-based ink containing a radiation-polymerizable compound.

### BACKGROUND OF THE INVENTION

1. Field of the Invention

The present invention relates to an image forming apparatus having a liquid ejection head, and more particularly to an image forming apparatus in which the liquid ejection head is a shear mode head.

2. Description of the Related Art

As an image forming apparatus in the related art, an inkjet printer (inkjet recording apparatus) is known which comprises an inkjet printer head (liquid ejection head) having an arrangement of a plurality of liquid ejection nozzles and which records images on a recording medium by ejecting ink (liquid) from the nozzles toward the recording medium while moving the inkjet head and the recording medium relatively to each other.

An inkjet head of the inkjet printer of this kind has pressure generating units, each comprising, for example, a pressure chamber to which ink is supplied from an ink tank via an ink supply channel, a piezoelectric element which is driven by electrical signals in accordance with image data, a diaphragm which constitutes a portion of the pressure chamber and deforms in accordance with the driving of the piezoelectric element, and a nozzle which is connected to the pressure chamber and from which the ink inside the pressure chamber is ejected in the form of a droplet due to the volume of the pressure chamber being reduced by the deformation of the diaphragm. In the inkjet printer, one image is formed on a recording medium by combining dots formed by ink ejected from the nozzles of the pressure generating units.

A shear mode head is one type of the inkjet head of this kind. In comparison with other types of heads using piezoelectric elements, a shear mode head has the following characteristics, for example: it can be composed at higher density and the longer lifespan can be achieved. A shear mode head has a structure in which electrodes are provided inside the ink chambers, and several inventions aimed at increasing the practical utility of such heads with regard to the ink have been disclosed.

Japanese Patent Application Publication No. 2002-355966 discloses an invention relating to a composition in which aqueous ink is ejected by using a shear mode head, wherein electrodes provided inside ink chambers of the head are covered with an insulating layer in order to provide electrical insulation and to prevent corrosion of the electrodes.

Japanese Patent Application Publication No. 2003-19797 discloses a material for a protective film which covers each electrode in a shear mode head in order to protect the electrodes, and a method of forming same.

The invention described in Japanese Patent Application Publication No. 2002-355966 provides a method for preventing problems involved in using an aqueous ink, such as the fact that the ink is conductive and the fact that the ink corrodes the metal forming the electrodes. However, if an aqueous ink is not used, then problems of this kind do not arise.

The invention described in Japanese Patent Application Publication No. 2003-19797 discloses a method and material for forming a protective film on each electrode in order to provide electrical insulation and waterproofing. However, if an ink which causes problems of this kind is not actually used, then there is no requirement to form such a protective film.

For example, if an oil-based ink which does not have any water content is used as the ink, then there is no need to form a protective film in order to provide electrical insulation or to prevent corrosion of the electrodes.

It was found on the basis of the evaluation results for the ink deposition tests described below that when an oil-based UV (ultraviolet curable) ink containing a radiation-polymerizable compound was used in a shear mode head, the ink depositing position was displaced from the prescribed position, and in particular when the apparatus was used continuously for a long period of time, this displacement of the depositing position was marked and it was difficult to deposit ink at the prescribed depositing position. If the depositing position of the ink is displaced from the desired position in this way, then the formed image differs from the intended image and an image of poor quality is created. Consequently, no matter how high the nozzle density becomes in the shear mode head, it is difficult to obtain an image of high quality unless a problem caused by the displacement in the depositing position of the ink is resolved.

### SUMMARY OF THE INVENTION

The present invention has been contrived in view of the foregoing circumstances, an object thereof being to provide an image forming apparatus comprising a shear mode liquid ejection head having a structure whereby there is virtually no change in the depositing position of the ink, even if an oil-based ultraviolet-curable ink is used in the shear mode head and the head is operated for a long period of time.

In order to attain the aforementioned object, the present invention is directed to an image forming apparatus having a shear mode liquid ejection head for ejecting ink, the shear mode liquid ejection head comprising: a pressure chamber into which the ink is filled; and a liquid affinity film which is made from a material containing a polyparaxylylene or a derivative of polyparaxylylene and is formed on an interior wall of the pressure chamber, wherein the ink is an oil-based ink containing a radiation-polymerizable compound.

Preferably, the radiation-polymerizable compound is a cationic polymerization compound.

Preferably, the liquid affinity film is formed all over the interior wall of the pressure chamber.

As described above, according to the present invention, a beneficial effect is obtained in that even if an oil-based UV ink containing a radiation-polymerizable compound is ejected from a shear mode liquid ejection head for a long period of time, there is virtually no change in the depositing position of the ink. Hence, even in cases where an image forming apparatus including such a head is used for a long time, there is no degradation of the image quality, and high density images can be obtained in a stable fashion over a long period of time.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIGS. 1A and 1B are cross-sectional diagrams of a liquid ejection head forming an image forming apparatus according to an embodiment of the present invention;

FIG. 2 is a general schematic drawing of an inkjet recording apparatus forming an image forming apparatus according to an embodiment of the present invention;

FIG. 3 is a principal plan diagram of the peripheral area of a print unit in the inkjet recording apparatus shown in FIGS. 1A and 1B; and

FIG. 4 is a block diagram showing the system configuration of an inkjet recording apparatus forming an image forming apparatus according to an embodiment of the present embodiment.

### DETAILED DESCRIPTION OF THE PREFERRED EMBODIMENTS

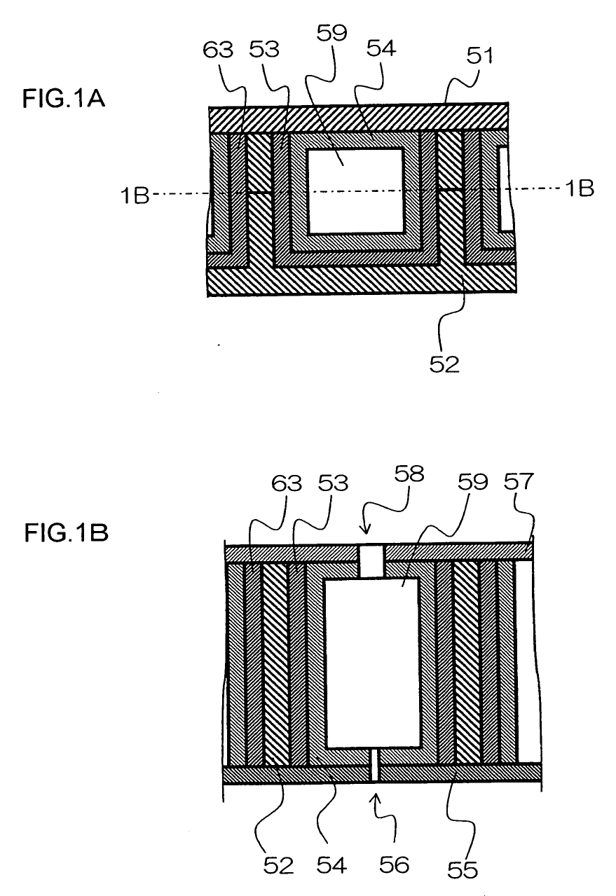

FIGS. 1A and 1B are diagrams showing a structure of a liquid ejection head which is mounted in an image forming apparatus of an embodiment according to the present invention. FIG. 1A is a cross-sectional diagram showing the portion corresponding to one nozzle in the liquid ejection head according to the present embodiment, as viewed from the direction of the nozzle, and FIG. 1B is a cross-sectional diagram along line 1B-1B in FIG. 1A. The liquid ejection head according to the present embodiment is a head which is generally referred to as a “shear mode head”.

The liquid ejection head according to the present embodiment comprises pressure chambers (ink channels) 59 each of which is enclosed by, an upper plate 51 including a flat plate of glass, ceramic, metal or plastic, a nozzle plate 55, and a rear surface plate 57.

The piezoelectric substrate 52 is formed from a material including lead zirconate titanate (PZT) (Pb(Zr, Ti)O₃). PZT is a desirable material since it has excellent piezoelectric characteristics in relation to the piezoelectric constant, high-frequency response performance, and the like. Other materials, such as BaTiO₃ and PbTiO₃, may also be used for forming the substrate. As shown in FIG. 1A, the piezoelectric substrate 52 is composed by combining two piezoelectric material members with adhesive. One of the two piezoelectric material members has a projecting shape, and the other is bonded therewith.

As shown in FIGS. 1A and 1B, electrodes 53 and 63 are formed on the projecting portions of the piezoelectric substrate 52. For the electrodes 53 and 63, a metal film made of gold, silver, aluminum, palladium, nickel, titanium, or the like, is formed to approximately 1 μm by plating, vacuum vapor deposition, or sputtering.

The upper plate 51 should have high mechanical strength and ink resisting properties, and it is particularly desirable to use a ceramic substrate. Considering that the upper plate 51 which is bonded with a PZT substrate to be deformed is used, it is desirable to use a non-piezoelectric ceramic substrate which has enough mechanical strength to support the side walls of the piezoelectric ceramic so as to prevent the displacement and which displays little deformation itself. More specifically, substrates having a principal component of aluminum oxide, zirconium oxide, silicon nitride, aluminum nitride, quartz, or the like, may be cited as examples of the upper plate 51. In particular, a substrate containing aluminum oxide as a principal component is desirable, since such a substrate has excellent insulating properties and prevents breakage due to thermal expansion and stress even if the substrate is thin.

The nozzle plate 55 is made, specifically, of a plastic material, such as polyimide or polycarbonate. A nozzle 56 for ejecting ink is provided in the nozzle plate 55, for each pressure chamber 59.

The rear surface plate 57 is a substrate in which liquid supply holes 58 are provided, and the liquid supply holes 58 correspond to the pressure chambers 59 respectively. Whenever ink is ejected from a nozzle 56, further ink is accordingly supplied via a liquid supply hole 58.

The surfaces which form the pressure chambers 59 constituted by the above-mentioned members, namely, all of the six internal wall surfaces of each pressure chamber 59, are each provided with a parylene film which is formed thereon as a liquid affinity film 54 (which has affinity for the ink used). The parylene film is a film made of a polyparaxylylene resin and/or a resin derived from a polyparaxylylene resin, and it is formed by CVD using a solid diparaxylylene dimer or a derivative of a solid diparaxylylene dimer as a starter material. More specifically, the liquid affinity film 54 is formed by means of a polymerization reaction in which a diradical paraxylylene monomer generated by evaporating and pyrolyzing a diparaxylylene dimer is adsorbed onto a substrate.

In the liquid ejection head manufactured in this way, by applying an electric field between electrodes 53 and 63, the corresponding piezoelectric substrate 52 deforms, the volume of the corresponding pressure chamber 59 is changed, and ink is ejected from the corresponding nozzle 56 accordingly.

As described hereinafter, an oil-based ink having hardly any water content is used as an ultraviolet-curable ink, and it has good affinity with the liquid affinity film 54.

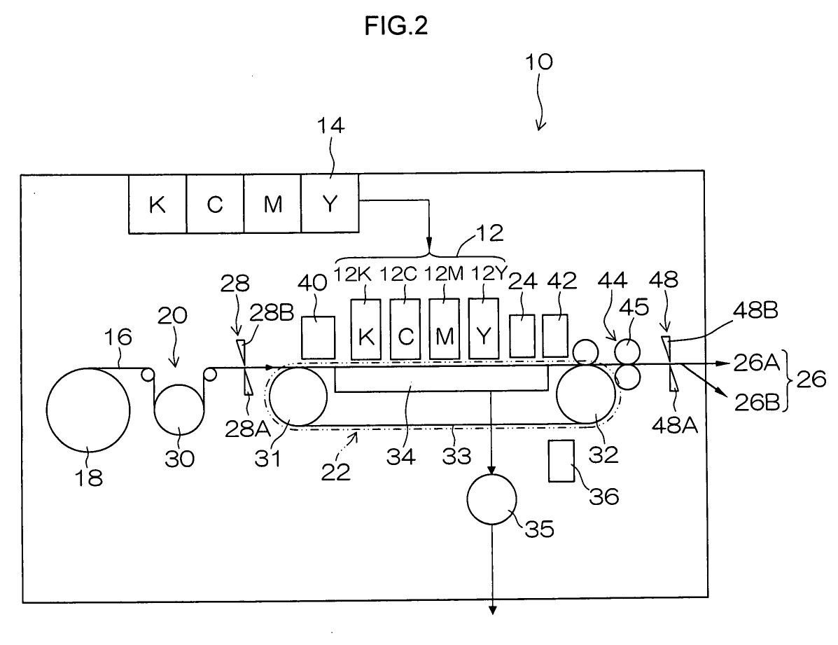

Below, an image forming apparatus according to an embodiment of the present invention is described with reference to FIG. 2.

FIG. 2 is a general schematic drawing showing an approximate view of an image forming apparatus including an inkjet head (liquid ejection head) according to an embodiment of the present invention.

As shown in FIG. 2, the inkjet recording apparatus 10 comprises: a printing unit 12 having a plurality of print heads (liquid ejection heads) 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16; a belt conveyance unit 22 disposed facing the nozzle faces (ink-droplet ejection face) of the print unit 12, for conveying the recording paper 16 while keeping the recording paper 16 flat; a print determination unit 24 for reading the printed results produced by the printing unit 12; a paper output unit 26 for outputting image-printed recording paper (printed matter) to the exterior; and an ultraviolet light irradiation unit 42.

In FIG. 2, a magazine for rolled paper (continuous paper) is shown as an example of the paper supply unit 18; however, a plurality of magazines with papers of different paper width and quality may be jointly provided. Moreover, papers may be supplied in cassettes that contain cut papers loaded in layers and that are used jointly or in lieu of magazines for rolled papers.

In the case of a configuration in which roll paper is used, a cutter 28 is provided as shown in FIG. 2, and the roll paper is cut to a desired size by the cutter 28. The cutter 28 has a stationary blade 28A whose length is not less than the width of the conveyor pathway of the recording paper 16, and a round blade 28B which moves along the stationary blade 28A. The stationary blade 28A is disposed on the reverse side of the printed surface of the recording paper 16, and the round blade 28B is disposed on the printed surface side across the conveyance path from the stationary blade 28A. When cut paper is used, the cutter 28 is not required.

In the case of a configuration in which a plurality of types of recording paper can be used, it is preferable that an information recording medium, such as a bar code and a wireless tag, containing information about the type of paper be attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this stage is preferably controlled so that the recording paper 16 has a curl in which the surface on which the print is to be made is slightly round outward.

The decurled and cut recording paper 16 is delivered to the belt conveyance unit 22. The belt conveyance unit 22 has a configuration in which an endless belt 33 is set around rollers 31 and 32 so that the portion of the endless belt 33 facing at least the nozzle faces of the printing unit 12 and the sensor face of the print determination unit 24 forms a plane (flat plane).

There are no particular limitations on the structure of the belt conveyance unit 22, and it may use a vacuum suction conveyance system in which the recording paper 16 is conveyed by being suctioned onto the belt 33 by negative pressure created by suctioning air through suction holes provided on the belt surface, or it may be based on electrostatic attraction.

The belt 33 has a width dimension that is broader than the width of the recording paper 16, and in the case of the vacuum suction conveyance method described above, a plurality of suction holes (not illustrated) are formed in the surface of the belt. A suction chamber 34 is disposed in a position facing the sensor surface of the print determination unit 24 and the nozzle surfaces of the printing unit 12 on the interior side of the belt 33, which is set around the rollers 31 and 32, as shown in FIG. 2; and this suction chamber 34 provides suction with a fan 35 to generate a negative pressure, thereby holding the recording paper 16 onto the belt 33 by the suction.

The belt 33 is driven in the clockwise direction in FIG. 2 by the motive force of a motor (not shown in the drawings) being transmitted to at least one of the rollers 31 and 32, which the belt 33 is set around, and the recording paper 16 held on the belt 33 is conveyed from the left to the right in FIG. 2.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, and a combination of these. In the case of the configuration in which the belt 33 is nipped with the cleaning rollers, it is preferable to make the line velocity of the cleaning rollers different from that of the belt 33 to improve the cleaning effect.

The inkjet recording apparatus 10 can comprise a roller nip conveyance mechanism, instead of the belt conveyance unit 22. However, there is a drawback in the roller nip conveyance mechanism that the print tends to be smeared when the printing area is conveyed by the roller nip action because the nip roller makes contact with the printed surface of the paper immediately after the printing. Therefore, the suction belt conveyance in which nothing comes into contact with the image surface in the printing area is preferable. A heating fan 40 is disposed on the upstream side of the printing unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

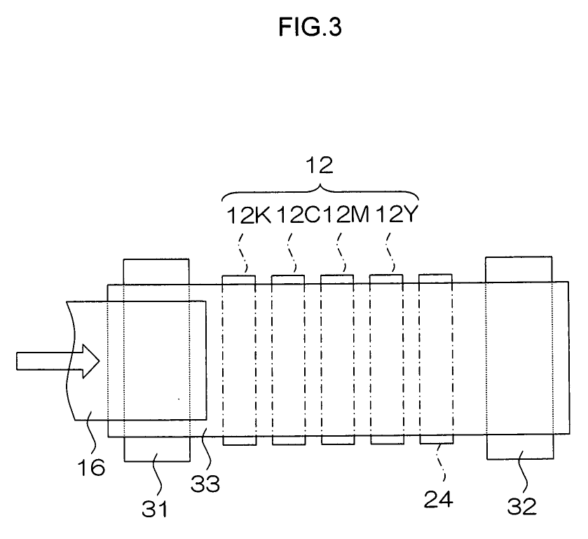

FIG. 3 is a principal plan diagram showing the periphery of the print unit 12 in the inkjet recording apparatus 10.

As shown in FIG. 3, the print unit 12 is a so-called “full line head” in which a line head having a length corresponding to the maximum paper width is arranged in a direction (main scanning direction) that is perpendicular to the paper conveyance direction (sub-scanning direction).

Each of the print heads 12K, 12C, 12M, and 12Y is constituted by a line head in which a plurality of ink ejection ports (nozzles) are arranged along a length that exceeds at least one side of the maximum-size recording paper 16 intended for use in the inkjet recording apparatus 10.

The print heads 12K, 12C, 12M, and 12Y are arranged in the order of black (K), cyan (C), magenta (M), and yellow (Y) from the upstream side (left side in FIG. 2), in the conveyance direction of the recording paper 16 (paper conveyance direction). A color image can be formed on the recording paper 16 by ejecting the inks from the print heads 12K, 12C, 12M, and 12Y, respectively, onto the recording paper 16 while the recording paper 16 is conveyed.

The print unit 12, in which the full-line heads covering the entire width of the paper are thus provided for the respective ink colors, can record an image over the entire surface of the recording paper 16 by performing the action of moving the recording paper 16 and the print unit 12 relative to each other in the paper conveyance direction (sub-scanning direction) just once (in other words, by means of a single sub-scan). Higher-speed printing is thereby made possible and productivity can be improved in comparison with a shuttle type head configuration in which a print head moves reciprocally in the direction (main scanning direction) that is perpendicular to the paper conveyance direction.

Here, the terms “main scanning direction” and “sub-scanning direction” are used in the following senses. More specifically, in a full-line head comprising rows of nozzles that have a length corresponding to the entire width of the recording paper, “main scanning” is defined as printing one line (a line formed of a row of dots, or a line formed of a plurality of rows of dots) in the breadthways direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other. The direction indicated by one line recorded by a main scanning action (the lengthwise direction of the band-shaped region thus recorded) is called the “main scanning direction”.

On the other hand, “sub-scanning” is defined as to repeatedly perform printing of one line (a line formed of a row of dots, or a line formed of a plurality of rows of dots) formed by the main scanning action, while the full-line head and the recording paper are moved relatively to each other. The direction in which sub-scanning is performed is called the sub-scanning direction. Consequently, the conveyance direction of the recording paper is the sub-scanning direction and the direction perpendicular to same is called the main scanning direction.

Although a configuration with four standard colors, K, M, C, and Y, is described in the present embodiment, the combinations of the ink colors and the number of colors are not limited to these, and light and/or dark inks can be added as required. For example, a configuration is possible in which print heads for ejecting light-colored inks, such as light cyan and light magenta, are added.

As shown in FIG. 2, the ink storing and loading unit 14 has ink tanks for storing the inks of the colors corresponding to the respective print heads 12K, 12C, 12M, and 12Y, and the respective tanks are connected to the print heads 12K, 12C, 12M, and 12Y by means of channels (not shown). The ink storing and loading unit 14 has a warning device (for example, a display device, an alarm sound generator, or the like) for warning when the remaining amount of any ink is low, and has a mechanism for preventing loading errors among the colors.

The print determination unit 24 has an image sensor (e.g., line sensor) for capturing an image of the ink-droplet deposition results of the printing unit 12, and functions as a device to check for ejection defects in the printing unit 12, such as clogs of the nozzles, from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the print heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the print heads 12K, 12C, 12M, and 12Y for the respective colors, and the ejection state of each head is determined. The ejection determination includes the presence of the ejection, measurement of the dot size, and measurement of the dot deposition position.

The ultraviolet light irradiation unit 42 is provided at a downstream stage from the print determination unit 24. The ultraviolet light irradiation unit 42 has an ultraviolet light source for fixing the ink by radiating radiation onto the inks ejected onto the recording medium 16.

If an ultraviolet light is radiated from the ultraviolet light source of the ultraviolet light irradiation unit 42 onto the nozzles of the heads 12C, 12M, 12Y and 12K which eject liquid ink droplets (a liquid containing an ultraviolet-curable polymerizable compound), then the ink inside the nozzles is cured, and hence it is necessary to position the ultraviolet light beam from the ultraviolet light irradiation unit 42 in such a manner that the ultraviolet light beam is not radiated onto the nozzles of the heads 12C, 12M, 12Y and 12K.

In cases where the heads 12C, 12M, 12Y and 12K are disposed in the vicinity of the ultraviolet light irradiation unit 42, desirably, a light shielding member which blocks the ultraviolet light radiated from the ultraviolet light source of the ultraviolet light irradiation unit 42 is provided for the heads 12C, 12M, 12Y and 12K.

A heating/pressurizing unit 44 is disposed following the ultraviolet light irradiation unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in the drawings, the paper output unit 26A for target prints is provided with a sorter for collecting prints according to print orders.

### Description of Ink

Next, the ink used in the inkjet recording apparatus according to the present embodiment is described.

The inks used in the inkjet recording apparatus according to the present embodiment may be a radical polymerization ink, and may be a cationic polymerization ink. As for the inks, inks of the respective colors containing a polymerization initiator, a polymerizable compound, a coloring material and other compounds, are used. Below, the materials constituting the inks are described.

### Polymerizable Compound

The term “polymerizable compound” is also referred to as “radiation-curable monomer or oligomer”. Desirably, the polymerizable compound used in a radical polymerization type ink has a polymerizable group, such as an acryloyl group, a methacryloyl group, an allyl group, a vinyl group, or an internal dual bonding group (which is in, for example, maleic acid); and of these, the compounds containing an acryloyl group or a methacrylol group are more desirable, since they can generate a curing reaction at low energy.

As examples of a polymerizable compound used in a cationically polymerizable ink (i.e., a cationic polymerization ink), it is possible to cite an alicyclic epoxy compound, an aliphatic epoxy compound, an oxetane derivative, and a vinyl ether compound.

In one liquid, it is possible to use one type of polymerizable compound only, or to use a combination of two or more types of polymerizable compounds.

The content ratio of the polymerizable compound in the liquid containing a coloring material is desirably in the range of 50 to 99 wt % (weight percentage) in the liquid, more desirably, in the range of 70 to 99 wt % in the liquid, and even more desirably, in the range of 80 to 99 wt % in the liquid.

### Polymerization Initiator

The term “polymerization initiator” is also referred to as “curing initiator” or “reaction initiator”. As examples of the polymerization initiator used for a radical polymerization type ink, it is possible to cite compounds such as an acetophenone derivative, a benzoin ether derivative, a benzyl dialkyl ketal derivative, and an acylphosphine oxide derivative.

As examples of a polymerization initiator used for a cationic polymerization ink, it is possible to cite onium salt type polymerization initiators such as an aryl diazonium salt, a diaryl iodonium salt, a triaryl sulphonium salt, and a phenacyl sulphonium salt, and non-ionic polymerization initiators such as an iron-arene complex, a sulphonate ester, and a silanol/aluminium complex.

From the viewpoints of stability over time, curing characteristics, and curing speed, desirably, the content ratio of the polymerization initiator in the ink is 0.5 to 20 wt %, more desirably, 1 to 15 wt %, and even more desirably, 3 to 10 wt %.

For the polymerization initiator, it is possible to use one type of initiator, or to use a combination of two or more types of initiators. Furthermore, provided that the beneficial effects of the present invention are not impaired, it is also possible to use a commonly known sensitizer in conjunction with it, in order to improve sensitivity.

### Coloring Agent

The term “coloring agent” is also referred to as “coloring material”, “pigment”, or “dye”. There are no particular restrictions on the coloring material used in the present invention, and provided that the coloring material achieves a color hue and color density that matches the object of use of the ink, it is possible to select a coloring material appropriately from commonly known aqueous dyes, oil-soluble dyes and pigments. Of these, it is desirable that the liquid forming the inkjet recording ink of an embodiment of the present invention be a non-aqueous liquid which does not contain an aqueous solvent, from the viewpoints of the stability of ink droplet ejection and rapid drying properties. In respect of these points, it is preferable to use an oil-soluble dye or pigment which can be readily dispersed and dissolved uniformly in a non-aqueous liquid solution.

There are no particular restrictions on the oil-soluble dyes which are usable in embodiments of the present invention, and any desired oil-soluble dye may be used. Preferably, in a case where an oil-soluble dye is used as the coloring material, the content ratio (converted to solid) of the dye is in the range of 0.05 to 20 wt %, more desirably, 0.1 to 15 wt %, and especially desirably, 0.2 to 6 wt %. A mode in which a pigment is used as the coloring material is desirable, from the viewpoint of enabling easy aggregation by mixing a plurality of types of liquids.

For pigments used in embodiments of the present invention, it is possible to use either an organic pigment or an inorganic pigment, and as regards a black pigment, a carbon black pigment, and the like, is desirable. Furthermore, in general, pigments of black and three primary colors of cyan, magenta and yellow are used, but depending on the required objective, it is also possible to use pigments having color hues such as red, green, blue, brown, and white, to use metallic lustrous pigments such as gold and silver, to use colorless body pigments, or to use light colored body pigments.

Moreover, for the pigments, it is also possible to use particles in which dye or pigment is affixed on the surface of a core material formed by a particle of silica, alumina, resin, or the like, or to use an insoluble lake compound of a dye, a colored emulsion, a colored latex, or the like.

Furthermore, it is also possible to use pigments that are coated with resin. One of these pigments is called a micro-capsule pigment, and can be acquired as commercial products, from Dainippon Ink and Chemicals Inc., Toyo Ink Mfg. Co., Ltd., and the like.

From the viewpoint of achieving a balance between optical density and storage stability, preferably, the volume-average particle diameter of the pigment particles contained in the liquid according to an embodiment of the present invention is in the range of 30 to 250 nm, and more preferably, 50 to 200 nm. Here, the volume-average particle size of the pigment particles can be measured by measurement apparatuses, such as an LB-500 (manufactured by HORIBA Ltd.).

From the viewpoints of optical density and ejection stability, in a case where a pigment is used as a coloring material, the content ratio of the pigment (converted to a solid) is desirably in the range of 0.1 wt % to 20 wt % in the ink, and more desirably, in the range of 1 wt % to 10 wt % in the ink.

For the coloring agents, it is possible to use only one type of coloring material, or to use a combination of two or more types of coloring materials. Moreover, it is possible to use different coloring materials or the same coloring material, for the liquids.

There are no particular restrictions on the material used as a coloring agent in both the radical polymerization ink and the cationic polymerization ink, and provided that a color hue and color density that meet the object of use of the ink are achieved, it is possible to select a coloring material appropriately from the oil-soluble dyes and pigments described above.

### Other Additives

In both a radical polymerization type ink and a cationic polymerization type ink, it is possible to use other commonly known additives, such as a dispersant, a solvent, a polymer, a surface tension adjuster, an ultraviolet absorbent, an oxidation inhibitor, a color fade inhibitor, and a pH adjuster, together with the above-mentioned polymerizable compounds, polymerization initiators, and coloring agents.

### Energy Application Step

For an exposure light source used in embodiments of the present invention to promote the polymerization of the polymerizable compound, it is possible to use ultraviolet light, visible light, or the like. Moreover, it is also possible to apply energy by means of radiation other than light, and for example, an α ray, a γ ray, an X ray, an electron beam, or the like can be used for the energy application. Of these options, it is preferable that ultraviolet light or visible light be used from the viewpoints of cost and safety, and use of ultraviolet light is especially preferable. The amount of energy required for the curing reaction varies depending on the type and amount of the polymerization initiator, and in general, it is about 1 to 500 mJ/cm².

In cases where a radical polymerization type ink is used, polymerization starts when the polymerization initiator generates radicals because of irradiation of light (UV light). This type of ink is inexpensive and is generally used as an ink for inkjet printing at present.

In cases where a cationic polymerization ink is used, polymerization starts when the polymerization initiator generates acid because of irradiation of light (UV light). This type of ink displays little contraction in volume upon curing, creates little odor or little skin irritation, and is expensive.

Next, the evaluation results for the deposition tests in an image forming apparatus having a liquid ejection head according to the present embodiment is described with reference to the following Table 1.

The inks used in this test evaluation had the compositions described below. Radical polymerization ink

(i) Dispersed pigment material: A pigment (PB 15:3 (IRGALITE BLUE GLO) which is manufactured by Ciba Specialty Chemicals Inc.) dispersed in HDDA (1,6-hexane diol diacrylate which is manufactured by Daicel-Cytec Co. Ltd.) by using a high-polymer dispersant (pigment concentration of 15 wt %)

(ii) Polymerizable compound: HDDA (1,6-hexane diol diacrylate which is manufactured by Daicel-Cytec Co. Ltd.)

(iii) Polymerizable compound: DPCA60 (manufactured by Nippon Kayaku Co. Ltd.)

(iv) Polymerization initiator: Irg907 (manufactured by Ciba Specialty Chemicals Inc.)

The radical polymerization ink which was used in the deposition tests included: 10 wt % of the dispersed pigment material denoted by (i); 82 wt % of the polymerizable compound denoted by (ii); 3 wt % of the polymerizable compound denoted by (iii); and 5 wt % of the polymerization initiator denoted by (iv).

### Cationic Polymerization Ink

(v) Dispersed pigment material: A pigment (PB 15:3 (IRGALITE BLUE GLO) which is manufactured by Ciba Specialty Chemicals Inc.) dispersed in Aron Oxetane OXT-221 (manufactured by Toagosei Co. Ltd.) by using a high-polymer dispersant (pigment concentration of 15 wt %)

(vi) Polymerizable compound: Aron Oxetane OXT-221 (manufactured by Toagosei Co. Ltd.)

(vii) Polymerizable compound: Celoxide 2021P (manufactured by Daicel-Cytec Co. Ltd.)

(viii) Polymerization initiator: SP-152 (manufactured by Asahi Denka Co. Ltd.)

The cationic polymerization ink which was used in the deposition tests included: 10 wt % of the dispersed pigment material denoted by (v); 60 wt % of the polymerizable compound denoted by (vi); 25 wt % of the polymerizable compound denoted by (vii); and 5 wt % of the polymerization initiator denoted by (viii).

In Comparative Example 1 of the following Table 1, ink was ejected immediately after the liquid ejection head which had a similar structure to that of the liquid ejection head shown in FIGS. 1A and 1B and in which no liquid affinity film 13 is formed was filled with ink. In Comparative Example 2 of Table 1, ink was ejected immediately after the liquid ejection head as shown in FIGS. 1A and 1B in which a polyimide film was used as the liquid affinity film 13 and it was formed only onto the electrode portions of the pressure chambers (70% of the total) was filled with ink. In Comparative Example 3 of Table 1, after this head in Comparative Example 2 was used continuously for 100 hours, ink was ejected.

Moreover, in Embodiment 1 of Table 1, ink was ejected immediately after the liquid ejection head as shown in FIGS. 1A and 11B in which a parylene film was formed as the liquid affinity film 13 only onto the electrode portions of the pressure chambers (70% of the total) was filled with ink. In Embodiment 2 of Table 1, after this head in Embodiment 1 was used continuously for 100 hours, ink was ejected. In Embodiment 3 of Table 1, ink was ejected immediately after a liquid ejection head in which a perylene film was formed as the liquid affinity film 13 onto the whole of the pressure chambers was filled with ink. In Embodiment 4 of Table 1, after this head in Embodiment 3 was used continuously for 100 hours, ink was ejected.

The deposition tests were implemented with these liquid ejection heads, and the test evaluation was implemented according to the amount of displacement σ between the actual depositing position of an ink and the predetermined depositing position of the ink, on the basis of the following criteria.

Very good: σ<3.0 μm

Good: 3.0 μm≦σ<5.0 μm

Fair: 5.0 μm≦σ<10.0 μm

Unsatisfactory: 10.0 μm≦σ

If the amount of displacement σ is 3.0 μm or less, then there is no problem in terms of image quality, but if it is 10.0 μm or above, then the image quality is degraded markedly and an impression of poor image quality is created.

Consequently, in the case of Comparative Example 1 where no liquid affinity film was formed, there was marked deterioration of image quality in both cases of a radical polymerization ink and a cationic polymerization ink, right from the start of printing. With regard to Comparative Examples 2 and 3, when a polyimide film was formed as the liquid affinity film 54, the amount of displacement was not very large immediately after the ink filling; however, the amount of displacement becomes large after the continuous use for 100 hours, and especially in the case of a radical polymerization ink, the actual image suffered marked degradation of image quality.

On the other hand, when a parylene film was used as the liquid affinity film 54, there is little change in the amount of displacement σ of the depositing position in both a radical polymerization ink and a cationic polymerization ink, in the cases of both ejection immediately after the filling of ink and ejection after the 100 hours of use. In particular, when a parylene film was used as the liquid affinity film 54 and the ink used was a cationic polymerization ink, the amount of displacement σ was the smallest, and even after the 100 hours of use, the most satisfactory image having hardly any change in image quality was obtained.

Accordingly, the following views can be derived from these results: when a parylene film is used for forming the liquid affinity film 54 over the entire surface of the interior of the pressure chambers, in the cases of both a radical polymerization ink and a cationic polymerization ink, there is virtually no problem at all in terms of image quality even after the 100 hours of use; and furthermore, in the case of a cationic polymerization ink, even if the coverage rate of the parylene film is 70%, there is little change in the displacement after the 100 hours of use, and there is virtually no problem at all in terms of image quality.

The present invention is based on these evaluation results described above for the ink deposition tests.

TABLE 1

| | | | Radical | | Cationic | |
|---|---|---|---|---|---|---|
| | | | polymerization ink | | polymerization ink | |
| | Coating film | Coverage (%) | σ (μm) | Evaluation | σ (μm) | Evaluation |
| Comparative | No organic | 0 | 14.3 | Unsatisfactory | 13.4 | Unsatisfactory |
| Example 1 | film | | | | | |
| Comparative | Polyimide | 70 | 6.5 | Fair | 6.2 | Fair |
| Example 2 | film (ejection | | | | | |
| | immediately | | | | | |
| | after filling) | | | | | |
| Comparative | Polyimide | 70 | 11.2 | Unsatisfactory | 8.5 | Fair |
| Example 3 | film (ejection | | | | | |
| | after 100 | | | | | |
| | hours use) | | | | | |
| Embodiment 1 | Parylene film | 70 | 3.5 | Good | 2.5 | Very good |
| | (ejection | | | | | |
| | immediately | | | | | |
| | after filling) | | | | | |
| Embodiment 2 | Parylene film | 70 | 3.8 | Good | 2.7 | Very good |
| | (ejection after | | | | | |
| | 100 hours | | | | | |
| | use) | | | | | |
| Embodiment 3 | Parylene film | 100 | 2.8 | Very good | 1.9 | Very good |
| | (ejection | | | | | |
| | immediately | | | | | |
| | after filling) | | | | | |
| Embodiment 4 | Parylene film | 100 | 2.7 | Very good | 2.1 | Very good |
| | (ejection after | | | | | |
| | 100 hours | | | | | |
| | use) | | | | | |

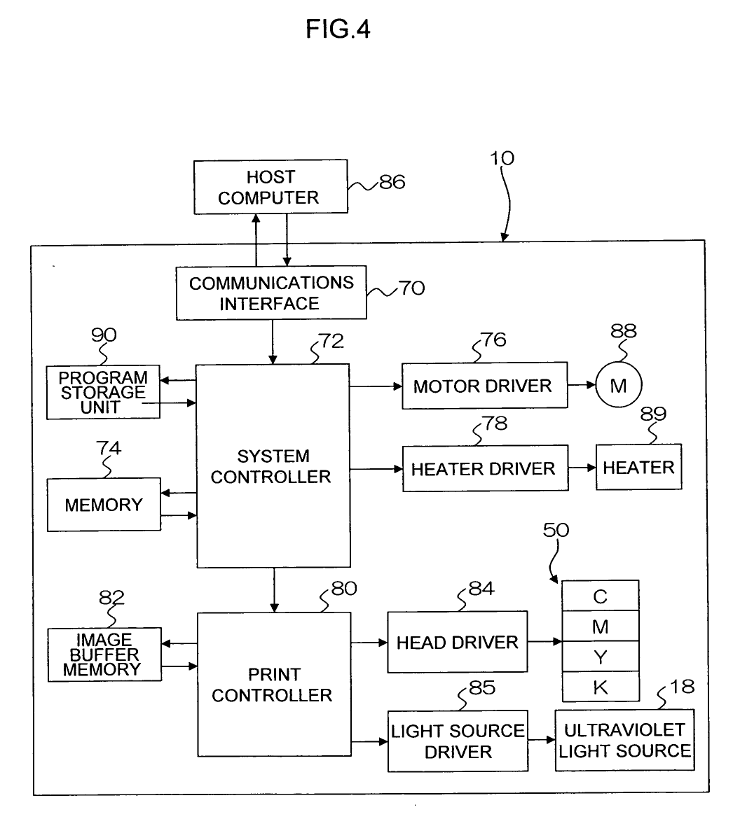

FIG. 4 is a principal block diagram showing the system configuration of the inkjet recording apparatus 10. The inkjet recording apparatus 10 comprises a communications interface 70, a system controller 72, an image memory 74, a motor driver 76, a heater driver 78, a print controller 80, an image buffer memory 82, a head driver 84, a light source driver 85, and the like.

The communications interface 70 is an interface unit for receiving image data sent from a host computer 86. A serial interface, such as USB (Universal Serial Bus), IEEE1394, Ethernet (registered trademark), wireless network, or a parallel interface such as a Centronics interface, may be used as the communications interface 70. A buffer memory (not shown) may be mounted in this portion in order to increase the communication speed. The image data sent from the host computer 86 is received by the inkjet recording apparatus 10 through the communications interface 70, and is temporarily stored in the image memory 74.

The image memory 74 is a storage device for temporarily storing images inputted through the communications interface 70, and data is written and read to and from the image memory 74 through the system controller 72. The image memory 74 is not limited to a memory composed of semiconductor elements, and a hard disk drive or another magnetic medium may be used.

The system controller 72 is constituted by a central processing unit (CPU) and peripheral circuits thereof, and the like. The system controller 72 functions as a control device for controlling the whole of the inkjet recording apparatus 10 in accordance with prescribed programs, and a calculation device for performing various calculations. More specifically, the system controller 72 controls the various sections, such as the communications interface 70, image memory 74, motor driver 76, and heater driver 78, and controls the communications with the host computer 86 and writing and reading to and from the image memory 74. The system controller 72 also generates control signals for controlling the motor 88 of the conveyance system and heater 89.

Programs executed by the CPU of the system controller 72 and the various types of data which are required for control procedures are stored in the image memory 74. The image memory 74 may be a non-writeable storage device, and it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 in accordance with commands from the system controller 72. The heater driver 78 drives the heater 89 in accordance with commands from the system controller 72. Embodiments of the heater 89 include heaters of a heating drum and a heating fan shown in FIG. 2.

The print controller 80 has a signal processing function for performing various tasks, compensations, and other types of processing for generating print control signals from the image data stored in the image memory 74 in accordance with commands from the system controller 72 so as to supply the generated print data (dot data) to the head driver 84. Required signal processing is carried out in the print controller 80, and the ejection amount and the ejection timing of the ink droplets from each of the print heads 50 are controlled via the head driver 84, on the basis of the print data. By this means, desired dot size and dot positions can be achieved.

The print controller 80 is provided with the image buffer memory 82; and image data, parameters, and other data are temporarily stored in the image buffer memory 82 when image data is processed in the print controller 80. Also possible is an aspect in which the print controller 80 and the system controller 72 are integrated to form a single processor.

The head driver 84 drives actuators of the heads of the respective colors 12C, 12M, 12Y and 12K on the basis of print data supplied by the print controller 80. The head driver 84 may include a feedback control system for maintaining constant drive conditions for the print heads.

The image data to be printed is externally inputted through the communications interface 70, and is stored in the image memory 74. In this stage, the RGB image data is stored in the image memory 74.

The image data stored in the image memory 74 is sent to the print controller 80 through the system controller 72, and is converted to the dot data for each ink color in the print controller 80. In other words, the print controller 80 performs processing for converting the inputted RGB image data into dot data for four colors, K, C, M and Y. The dot data generated by the print controller 80 is stored in the image buffer memory 82.

The head driver 84 generates drive control signals for the heads 50 on the basis of the dot data stored in the image buffer memory 82. By supplying the drive control signals generated by the head driver 84 to the heads 50, ink is ejected from the heads 50. By controlling ink ejection from the heads 50 in synchronization with the conveyance velocity of the recording medium 16, an image is formed on the recording medium 16.

Various control programs are stored in a program storage section 90, and the control program are read out and executed in accordance with commands from the system controller 72. The program storage section may use a semiconductor memory, such as a ROM, EEPROM, or a magnetic disk, or the like. An external interface may be provided, and a memory card or PC card may also be used. A plurality of these storage media may also be provided. The program storage section 90 may also be combined with a storage device (not shown) for storing operational parameters, and the like.

The print controller 80 controls the ultraviolet light source 18 through the light source driver 85. In other words, the light source driver 85 controls the on/off switching, the irradiation amount, the irradiation time, and the like, of the ultraviolet light source 18, in conjunction with the control of the conveyance of the recording medium 16, on the basis of control signals sent from the print controller 80 to the light source driver 85.

The image forming apparatus according to an embodiment of the present invention has been described in detail above, but the present invention is not limited to the aforementioned examples, and it is possible for improvements or modifications of various kinds to be implemented, within a range which does not deviate from the essence of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus having a shear mode liquid ejection head for ejecting ink, the shear mode liquid ejection head comprising:
a pressure chamber into which the ink is filled; and
a liquid affinity film which is made from a material containing a polyparaxylylene or a derivative of polyparaxylylene and is formed on an interior wall of the pressure chamber,
wherein the ink is an oil-based ink containing a radiation-polymerizable compound.

2. The image forming apparatus as defined in claim 1, wherein the radiation-polymerizable compound is a cationic polymerization compound.

3. The image forming apparatus as defined in claim 1, wherein the liquid affinity film is formed all over the interior wall of the pressure chamber.
